(19) United States
(12) Patent Application Publication
(10) Pub. No.: US 2005/0006965 A1
(43) Pub. Date: Jan. 13, 2005

(54) Rotational driving device

(75) Inventors: Masao Sato, Tokyo (JP); Hideto Nishimura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/887,874

(22) Filed: Jul. 12, 2004

(30) Foreign Application Priority Data
Jul. 10, 2003 (JP) P2003-195116

(51) Int. Cl. H02K 7/00; H02K 11/00; H02K 5/16; H02K 7/08; G11B 17/08

(52) U.S. Cl. 310/67 R; 310/DIG. 6; 310/91; 310/90; 310/254; 360/99.08; 360/98.07

(57) ABSTRACT

An rotational driving device in which electric circuit board is provided with stepped shape fastening parts each including a cylindrical fitting portion having a thin depression and a rest seat portion serving as a seat plane for receiving an iron core and the fitting portions are fitted in three through holes made in the periphery of the iron core and after they are fitted, the depressions of the fitting portions are deformed outwardly nearly in the shape of an inverted cone to fasten and fix the iron core to the electric circuit board.

### BACKGROUND OF THE INVENTION

1. Field of the Invention

The present invention relates to a rotational driving device that has a structure for preventing an iron core composing a brushless motor from being removed or distorted and at the same time for preventing dust or the like from entering a gap between a ring magnet and the iron core thereby to improve reliability.

2. Description of the Related Art

In a rotational driving device for rotating a disk of a recording medium, usually a thin brushless motor is employed.

This brushless motor is composed of: a rotor part that has a rotary shaft and a ring magnet and rotates around the rotary shaft; a stator part that has an iron core formed by laminating a plurality of magnetic steel sheets, around which magnetic field generating coils are wound, and generates a magnetic field for rotating the rotor part; an electric circuit board on which an electric circuit for passing current through the magnetic field generating coils is formed; and the like.

For the brushless motor, a method for fixing the iron core forming the stator part is a very important technology having an effect on the reliability of the motor, that is, the reliability of the rotational driving device.

As comparative example 1 in the related art of a method for fixing the iron core in the brushless motor, it is well known a structure in which a core holder and an iron core are placed on an electric circuit board respectively, and are fastened via a press plate with fastening members to fix the iron core so that the iron core is put into absolute contact with a smooth portion of the press plate (for example, see patent document 1) .

In addition, another comparative example 2 in the related art of the method for fixing the iron core in the brushless motor is the following.

The iron core of this comparative example is formed by laminating a plurality of magnetic steel sheets each of which is punched out to have a circular outside shape. Each magnetic steel sheet has a plurality of caulking portions each depressed into a rectangular shape with a die. These caulking portions of the magnetic steel sheets are pressed each other to be combined into one piece thereby in order to form the iron core.

This iron core is pressed or shrink-fitted into a motor case in an axial direction, whereby the whole outer peripheral surface of the iron core is fitted in the motor case to fix the iron core (for example, see patent document 2).

Moreover, in the brushless motor of an inner rotor structure in the rotational driving device as still another comparative example 3 in the related art, cut and raised portions are formed by bending portions (for example, three portions) of a rotor housing, which is a constituent element of a rotor part, nearly in a shape of letter L, and the ring magnet is mounted and fixed at these cut and raised portions.

Therefore, in a case with this structure, the rotor housing has holes made by forming these cut and raised portions.

[Patent document 1] Japanese Unexamined Utility Model Publication No. 5-95195

[Patent document 2] Japanese Unexamined Patent Publication No. 4-325846

Since the rotational driving devices in the related art are composed in the manners described above, in a case of the method for fixing an iron core of the comparative example 1 in the related art, there is a possibility that the fastening members are loosened in a case where disturbances such as vibrations and impact are applied to the device. If the fastening members are loosened, the fixing of the iron core to the press plate becomes weak and the iron core is shifted from accurate position with respect to the ring magnet, which has an effect on the characteristics of the motor. Further, there is presented a problem that the iron core might be removed and break the motor.

Further, in this case of fixing the iron core with the fastening members, there is presented a problem of decreasing workability.

And in a case of the method for fixing the iron core in the comparative example 2 in the related art, when the whole outer peripheral surface of the iron core is fitted in the whole inner peripheral surface of the motor case by caulking and pressing, there is presented a problem that an internal strain is generated from the outer periphery to the inner periphery of iron core to increase the iron loss of iron core thereby to decrease efficiency of the motor.

Further, in the motor with the inner rotor structure of the comparative example 3 in the related art, the cut and raised portions are formed in the rotor housing and hold the ring magnet. Hence, this inevitably makes holes in the rotor housing.

For this reason, in a case where large foreign objects and dust enter the rotor part through the holes and get into the gap between the ring magnet and the iron core, there is presented a problem that the foreign objects and dust might lock the rotor part.

### SUMMARY OF THE INVENTION

The present invention has been made to solve the above described problems. It is an object of the present invention to provide a rotational driving device provided with a brushless motor that has a fixing structure capable of preventing an iron core from being removed or distorted and prevents an increase in iron loss thereby and hence prevents a decrease in motor efficiency.

Moreover, it is another object of the present invention to provide a rotational driving device provided with a brushless motor having a rotor-hole sealing structure in which holes made in a rotor housing are sealed to prevent foreign objects and dust from entering a gap between a ring magnet and an iron core thereby to form a motor of improved reliability.

A rotational driving device in accordance with the present invention includes: a plurality of through holes which are made in a periphery of the iron core, and a plurality of stepped fastening parts which are provided on the electric circuit board each of which is fitted in each of the through holes and then is caulked to grip the iron core between its top and rest seat portion.

Therefore, according to the present invention, it is possible to provide a rotational driving device provided with a brushless motor in which strain is not applied directly to the teeth portions of the iron core to prevent an increase in iron loss generated in the iron core thereby to prevent a decrease in motor efficiency.

In addition, according to the present invention, the fastening parts are deformed nearly in the shape of an inverted cone to fasten and fix the iron core. Therefore, it is possible to provide a rotational driving device provided with a brushless motor that improves workability, as compared with a case where the iron core is fastened and fixed with fastening members, and is resistant to vibrations and impact and hence prevents the iron core from being removed and thereby to improve reliability.

### BRIEF DESCRIPTION OF THE DRAWINGS

FIG. 1 is a transverse sectional view of a rotational driving device provided with a brushless motor in accordance with embodiment 1 of the present invention.

FIG. 2A is a plan view of a hole-sealing ring plate having a cutout and FIG. 2B is a plan view of a rotor part depicted by a rotor housing, a ring magnet, and the hole-sealing plate.

FIG. 3A is a plan view of a hole-sealing ring plate having no cutout and FIG. 3B is a plan view of a rotor part depicted by the rotor housing, the ring magnet and the hole-sealing plate.

FIG. 4 is a plan view of a main portion of the rotational driving device provided with the brushless motor in accordance with embodiment 1 of the present invention.

FIG. 5 is a plan view of a main portion of the rotational driving device, in which the rotor part is removed in FIG. 4 to show a state where the iron core is fixed.

FIG. 6 is a transverse sectional view of a rotational driving device provided with a brushless motor in accordance with embodiment 2 of the present invention.

FIG. 7 is a transverse sectional view of a rotational driving device provided with a brushless motor in accordance with embodiment 3 of the present invention.

FIG. 8 is a plan view of a main portion of the rotational driving device, in which the rotor part is removed in FIG. 7 to show the state where an electric circuit board is fixed.

FIG. 9 is a transverse sectional view of a rotational driving device provided with a brushless motor in accordance with embodiment 4 of the present invention.

FIG. 10 is a transverse sectional view of a rotational driving device provided with a brushless motor in accordance with embodiment 5 of the present invention.

FIG. 11 is a transverse sectional view of a rotational driving device provided with a brushless motor in accordance with embodiment 6 of the present invention.

FIG. 12 is a plan view of a main portion of the rotational driving device, in which the rotor part is removed in FIG. 11.

### DETAILED DESCRIPTION OF THE PREFERRED EMBODIMENTS

Hereinafter the preferred embodiments of the present invention will be described.

Embodiment 1

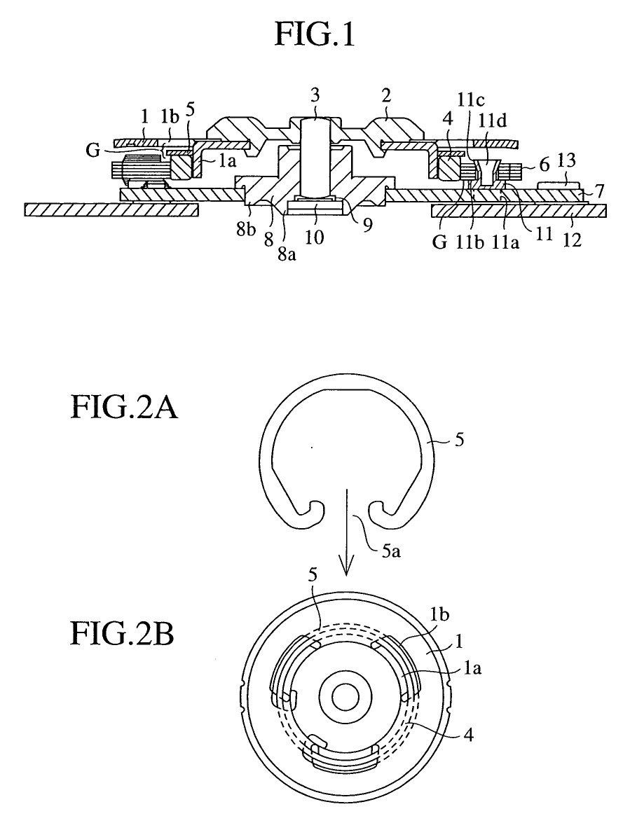

FIG. 1 is a transverse sectional view of a rotational driving device provided with a brushless motor in accordance with embodiment 1 of the present invention.

In FIG. 1, a rotor housing 1 also serves as a turntable having a surface on which a medium of a disk or the like in which information is recorded, is placed. The rotor part of a brushless motor is composed with this rotor housing 1, a rotor hub part 2 that is fastened to the rotor housing 1 to position the disk at a center position, a rotary shaft 3 that is pressed into the rotor hub part 2 and becomes a support shaft of the rotor housing 1, a ring magnet 4 that is mounted in a plurality of cut and raised portions 1a each of which is formed by bending a portion of the rotor housing 1 nearly in a shape of letter L and generates rotational force, and a hole-sealing ring plate 5 that is arranged between the rotor housing 1 and the ring magnet 4 so as to seal holes 1b, each of which is made by forming the cut and raised portion 1a in the rotor housing 1.

The hole-sealing ring plate 5 prevents foreign objects and dust from entering a gap G between the ring magnet 4 and an iron core 6 through the holes 1b.

The iron core 6 is mounted opposite to the ring magnet 4 of the above described rotor part. This iron core 6 is formed of a plurality of laminated magnetic steel sheets and forms a stator part of the brushless motor.

At this point, an electric circuit board 7 is provided with an electric circuit for generating a magnetic field to rotate the rotor housing 1, whereas is mounted with a bearing 8 for supporting the rotary shaft 3, a thrust receiving part 9 that receives a thrust of the rotary shaft 3, a holding plate 10 for holding the thrust receiving part 9, and fastening parts 11 that fasten and fix the iron core 6.

The fastening part 11 is a cylindrical (for example, a circular cylindrical) part that is formed in a stepped shape having a base portion 11a, a rest seat portion 11b and a fitting portion 11c and has a thin depression 11d on the inner peripheral side of top of the fitting portion 11c.

FIG. 2 are diagrams to explain a sealing of the hole 1b in FIG. 1. FIG. 2A is a plan view of the hole-sealing ring plate 5 having a cutout and FIG. 2B is a plan view of the rotor part depicted by the rotor housing 1, the ring magnet 4 and the hole-sealing plate 5.

In FIG. 2, in order to seal the holes 1b of the cut and raised portions 1a in FIG. 1, the hole-sealing plate 5 having cutouts 5a in portions of its periphery as shown in FIG. 2, is arranged between the rotor housing 1 and the ring magnet 4, as shown in FIG. 1, in order to seal three respective holes 1b. At this point, the hole-sealing plate 5 is arranged so that the cutout 5a of the hole-sealing plate 5 does not overlap the holes 1b.

The hole-sealing plate 5 can be arranged before or after the ring magnet 4 is mounted because it has the cutout 5a on its periphery.

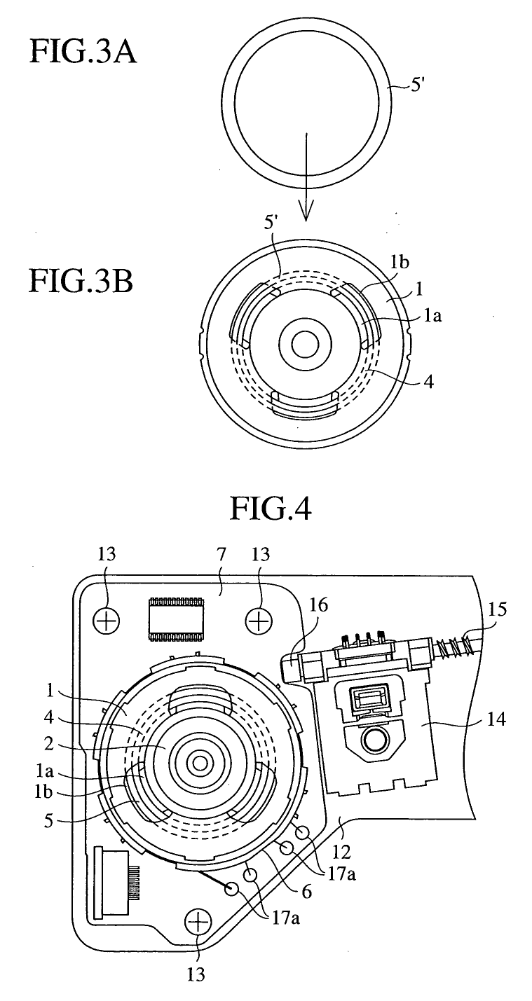

FIG. 3 are diagrams to explain a sealing of the holes 1b in FIG. 1 in accordance with another embodiment. FIG. 3A is a plan view of a hole-sealing ring plate 5′ having no cutout and FIG. 3B is a plan view of the rotor part depicted by the rotor housing 1, the ring magnet 4 and the hole-sealing plate 5′.

As shown in FIG. 3A, it is also recommended that the hole-sealing ring plate 5′ having no cutout may be arranged between the rotor housing 1 and the ring magnet 4, as shown in FIG. 1, in order to seal three respective holes 1b.

A method of arranging the hole-sealing plate 5′ in this case is as follows: the hole-sealing plate 5′ is inserted into the cut and raised portions 1a of the rotor housing 1 before the ring magnet 4 is mounted; and thereafter the ring magnet 4 is mounted and fixed with an adhesive or the like.

FIG. 4 is a plan view of a main portion of the rotational driving device shown in FIG. 1. The holes 1b of the cut and raised portions 1a formed on the three portions of the rotor housing 1, are sealed as described above by the hole-sealing plate 5 arranged between the rotor housing 1 and the ring magnet 4.

Here, an optical pickup mechanism 14 for recording and reproducing the information of disk is held by a base 12 and is moved in a direction parallel to the axis of a lead screw 15 while it is being engaged with the lead screw 15 when recording and reproducing of the disk is performed.

This lead screw 15 is held by a support member 16.

Moreover, the electric circuit board 7 is fixed to the base 12 at three positions with fastening members 13.

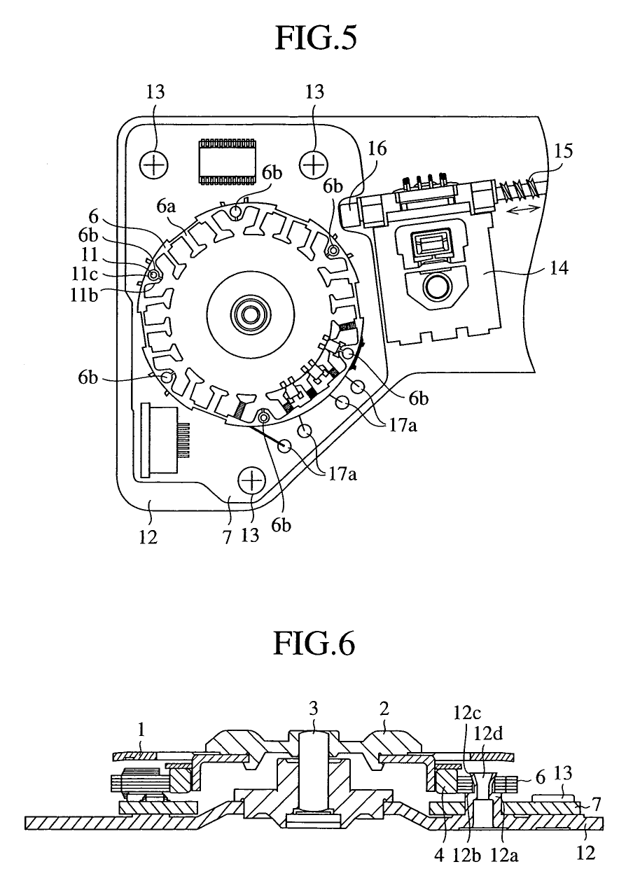

FIG. 5 is a plan view of a main portion of the rotational driving device, in which the rotor part is removed in FIG. 4 to show a state where the iron core 6 is fixed. In FIG. 5, the iron core 6 made of laminating a plurality of magnetic steel sheets is formed of six blocks of straight iron cores arranged in the form of an arc, wherein each block is formed of three teeth portions 6a. Magnetic field generating coils 17 for performing electromagnetic energy transformation are wound around these teeth portions 6a respectively, and generate a magnetic field for rotating the rotor part including the rotor housing 1, the ring magnet 4, and the like.

In addition, through holes 6b are made in the periphery of their on core 6 by each block of the plurality of teeth portions (n=3 teeth portions), that is, at six positions and the through holes 6b at three positions of these six positions are used for fastening the iron core 6 as will be described later.

The through holes 6b are made in the manner described above and are not made between three teeth portions 6a forming one block so as to prevent the three teeth portions 6a from being distorted.

Next, a fixing of the iron core 6 will be described with reference to FIG. 1 and FIG. 5.

As shown in FIG. 1, the base portion 11a of the fastening part 11 having the depression 11d formed thereon is fastened to the electric circuit board 7 by means of caulking or the like and, as shown in FIG. 5, to the rest seat portion 11b of the fastening part 11, the fitting portion 11c having a smaller diameter than the rest seat portion 11b is fitted into each of the three through holes 6b, shown by double circles in FIG. 5, of six through holes made in the periphery of the iron core 6 and after it is fitted, the top of the depression 11d of the fastening part 11 is outwardly deformed with a jig (not shown) or the like nearly in the shape of an inverted cone, as shown in FIG. 1, to fasten and fix the iron core 6 to the electric circuit board. 7.

Further, as shown in FIG. 1, the thrust receiving part 9 is fitted into the bearing 8 as a rest member in a direction of thrust of the rotary shaft 3 which is pressed into the rotor hub part 2, and the holding plate 10 for preventing the thrust receiving part 9 from being withdrawn is mounted in the bearing 8 and a protruding portion 8a of the bearing 8 is fixed by fixing means of caulking or the like.

Still further, the bearing 8 is mounted on the electric circuit board 7 and the protruding portion 8b of the bearing 8 is fixed to the electric circuit board 7 by fixing means of caulking or the like.

In addition, three-phase magnetic field generating coils 17 are wound around three teeth portions 6a (star connection) for each one block of the iron core 6 respectively, and four terminals 17a (one of which is a neutral point) of each magnetic field generating coil 17 are fixed to the electric circuit board 7 by means of soldering. This electric circuit board 7 is fastened to the base 12 with the fastening members 13.

As described above, according to this embodiment 1, the stepped shape fastening parts 11, each of which has the cylindrical fitting portion 11c having the thin depression lid on the inner peripheral side of its top and the rest seat portion 11b serving as a seat plane for receiving the iron core 6, are provided at three positions on the electric circuit board 7 and the fitting portions 11c are respectively inserted into the through holes 6b made at the three positions in the periphery of the iron core 6, and after they are fitted, the depressions 11d of the fastening parts 11c are outwardly deformed nearly in the shape of the inverted cone thereby to fasten and fix the iron core 6 to the electric circuit board 7. With this structure, it is possible to provide the rotational driving device provided with the brushless motor in which the iron core 6 is fastened and fixed between the blocks, each of which includes three teeth portions 6a, to prevent these three teeth portions 6a from being directly distorted, thereby to prevent an increase in iron loss generated in the iron core 6 and to prevent a decrease in motor efficiency.

Further, it is possible to provide the rotational driving device provided with the brushless motor which improves work ability because the fastening portions 11 are deformed nearly in the shape of an inverted cone to fasten and fix the iron core 6, as compared with a case where they are fixed with fastening members, and is resistant to vibrations and impact and hence prevents the iron core 6 from being removed and improves reliability.

Still further, the hole-sealing plate 5 having the cutout 5a or the hole-sealing plate 5′ having no cutout is arranged between the rotor housing 1 and the ring magnet 4 to seal the holes 1b of the cut and raised portions 1a that are made in the rotor housing 1 so as to mount the ring magnet 4. With this structure, it is possible to provide the rotational driving device provided with the brushless motor that can prevent the foreign objects and dust from entering the gap G between the ring magnet 4 and the iron core 6 to improve reliability.

Embodiment 2

FIG. 6 is a rotational driving device provided with a brushless motor in accordance with embodiment 2 of the present invention. At this point, the same parts as in FIG. 1 are denoted by the same reference symbols.

In the brushless motor in accordance with embodiment 1, the fastening part 11 for fastening and fixing the iron core 6 is provided on the electric circuit board 7. At this point, this fastening part 11 is a separate member from the electric circuit board 7.

In contrast to this, the brushless motor in accordance with embodiment 2 has a structure in which a fastening portion 12a for fastening and fixing the iron core 6 is provided on the base 12 and has a built-in structure in which the fastening portion 12a is protruded by drawing with ironing from the base 12, thereby being integrally formed with the base 12 and in which the iron core 6 is fastened and fixed by the integrally formed fastening portion 12a.

This fastening portion 12a is formed in the same stepped shape as the fastening part 11 in FIG. 1 and has a rest seat portion 12b, a fitting portion 12c, and a depression 12d. As described in FIG. 5, the fitting portion 12c is fitted in each of three through holes 6b made in the iron core 6 to the rest seat portion 12b and after it is fitted, the depression 12d is outwardly deformed nearly in the shape of an inverted cone, as shown in FIG. 6, to fasten and fix the iron core 6 to the base 12.

At this point, as for the positional relationship between the iron core 6 and the electric circuit board 7, as shown in FIG. 6, the iron core 6 is above the electric circuit board 7. This electric circuit board 7, as in FIG. 5, is fastened to the base 12 with fastening members 13.

As described above, according to this embodiment 2, the fastening portion 12a for fastening and fixing the iron core 6 is integrally formed with the base 12 in a protruding manner by drawing with ironing from the base 12, and the iron core 6 is fastened and fixed by the fastening portion 12a integrally formed with the base 12. With this structure, it is possible to produce an effect of eliminating the need for providing a separate fastening member and the same effect as in embodiment 1, that is, an effect of providing a rotational driving device provided with a brushless motor which can prevent an increase in iron loss generated in the iron core 6 to prevent a decrease in motor efficiency and is resistant to vibrations and impact and hence can prevent the iron core 6 from being removed thereby to improve reliability.

Embodiment 3

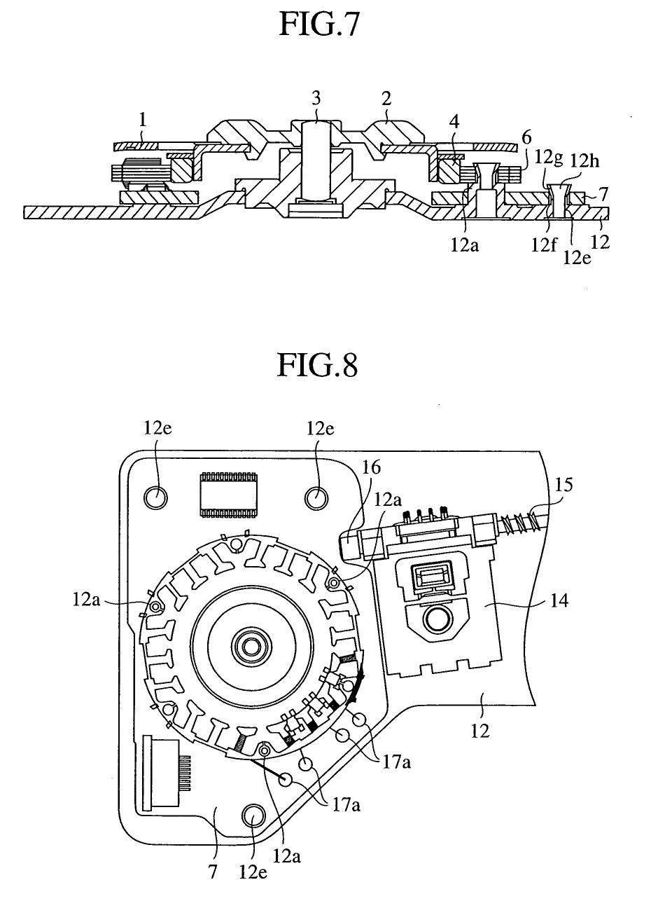

FIG. 7 is a transverse sectional view of a rotational driving device provided with a brushless motor in accordance with embodiment 3 of the present invention. FIG. 8 is a plan view of a main portion of the rotational driving device, in which the rotor part is removed in FIG. 7 to show a state where the electric circuit board 7 is fixed. At this point, the same parts as in FIG. 1 are denoted by the same reference symbols.

In embodiments 1 and 2, the electric circuit board 7 is fastened to the base 12 with the fastening members 13. In contrast to this, in this embodiment 3, in place of the fastening members 13 of separate members, fastening portions 12e for fastening the electric circuit board 7 to the base 12 are integrally formed with the base 12, that is, has a structure in which the built-in structure of embodiment 2 is expanded.

In FIG. 7, the integrally formed fastening portion 12e is formed in a protruded manner by drawing with ironing from the base 12, as is the case with the fastening portion 12a in FIG. 6.

This fastening portion 12e is formed in the same stepped shape as the fastening portion 12a in FIG. 6 and has a rest seat portion 12f, a fitting portion 12g, and a depression 12h. The fitting portions 12g are fitted in the fastening holes of the electric circuit board 7 to the rest seat portion 12f respectively, and after they are fitted, the depressed portions 12h are deformed outwardly nearly in the shape of an inverted cone, as shown in FIG. 7, to fasten and fix the electric circuit board 7 to the base 12. The state where the electric circuit board 7 is fastened and fixed to the base 12 at three positions will be shown in FIG. 8.

As described above, according to this embodiment 3, in place of the fastening members 13 of separate members that fasten the electric circuit board 7 to the base 12, the fastening portions 12e are integrally formed with he base 12 and the electric circuit board 7 is fastened and fixed to the base 12 by these fastening portions 12e. With this structure, it is possible to eliminate the need for providing separate fastening members.

Embodiment 4

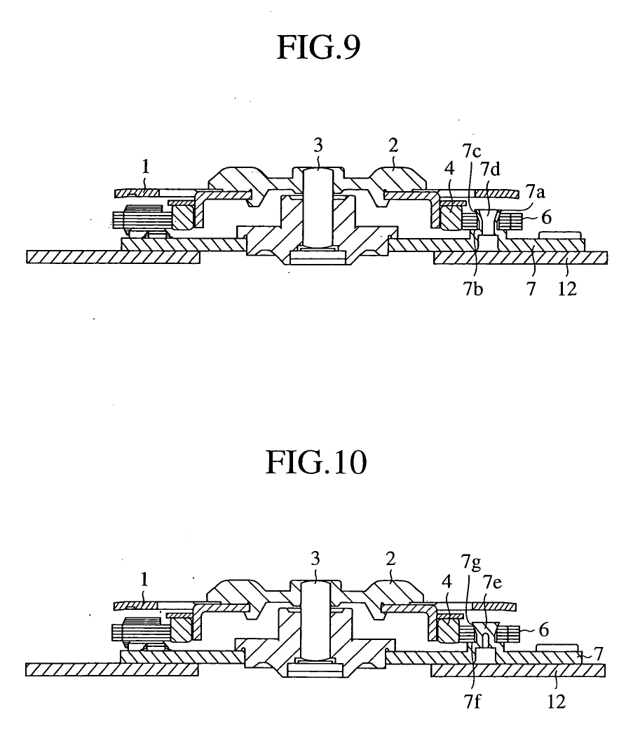

FIG. 9 is a transverse sectional view of a rotational driving device provided with a brushless motor in accordance with embodiment 4 of the present invention. At this point, the same parts as in FIG. 1 are denoted by the same reference symbols.

In the brushless motor of the above described embodiment 1, the fastening parts 11 for fastening and fixing the iron core 6 are provided as separate members on the electric circuit board 7.

In contrast to this, in the brushless motor of this embodiment 4, the fastening portions 7a for fastening and fixing the iron core 6 are integrally formed with the electric circuit board 7 in a protruded manner by drawing with ironing from the electric circuit board 7 and the iron core 6 are fastened and fixed to the electric circuit board 7 with these integrally formed fastening portions 7a.

As shown in FIG. 9, the fastening portion 7a integrally formed with the electric circuit board 7 is formed in the stepped shape having a rest seat portion 7b, a fitting portion 7c, and a depression 7d, as is the case with the fastening part 11 in FIG. 1 or the fastening portion 12a in FIG. 6.

At this point, a method for fastening and fixing the iron core 6 is the same as shown in FIG. 1 or FIG. 6, and hence its further description will be omitted.

As described above, according to this embodiment 4, the fastening and fixing portions 7a for fastening and fixing the iron core 6 are integrally formed with the electric circuit board 7 in a protruded manner by drawing with ironing from the electric circuit board 7 and the iron core 6 is fastened and fixed with these fastening portions integrally formed with the electric circuit board 7. With this structure, it is possible to produce an effect of eliminating the need for providing separate fastening members and the same effect as in embodiment 1, that is, an effect of providing a rotational driving device provided with a brushless motor which can prevent an increase in iron loss generated in the iron core 6 to prevent a decrease in motor efficiency and is resistant to vibrations and impact and hence can prevent the iron core 6 from being removed thereby to improve reliability.

Embodiment 5

FIG. 10 is a transverse sectional view of a rotational driving device provided with a brushless motor in accordance with embodiment 5 of the present invention. At this point, the same parts as in FIG. 1 are denoted by the same reference symbols.

In the above described embodiment 4, the integral-type fastening portion 7a for fastening and fixing the iron core 6 has a structure in which the fitting portion has the depression.

In contrast to this, a fastening portion 7e in this embodiment 5, as shown in FIG. 10, is formed in a stepped shape including a rest seat portion 7f and a fitting portion 7g formed in the shape of a column (for example, a cylindrical column) having no depression.

A method of fastening and fixing the iron core 6 by these fastening portions 7e is as follows: the fitting portions 7g are fitted in the through holes 6b (see FIG. 5) made at three positions of the iron core 6 to the rest seat portions 7f respectively, and after they are fitted, the fitting portions 7g are swaged and expanded at their tops, as shown in FIG. 10, to fasten and fix the iron core to the electric circuit board 7.

In this respect, the fastening portions 7e having no depression in this embodiment 5 may be applied to the above described embodiments 1 to 4.

As described above, according to this embodiment 5, the integral-type fastening portion 7e for fastening and fixing the iron core 6 is formed in the stepped shape including the rest seat portion 7f and the fitting portion 7g having no depression and after the fitting portions 7g are fitted in the through holes 6b of the iron core 6, the fitting portions 7g are swaged and expanded at their tops to fasten and fix the iron core 6 to the electric circuit board 7. With this structure, it is possible to produce the same effect as in embodiment 1, that is, an effect of providing a rotational driving device provided with a brushless motor which can prevent an increase in iron loss generated in the iron core 6 to prevent a decrease in motor efficiency and is resistant to vibrations and impact and hence can prevent the iron core 6 from being removed thereby to improve reliability.

Embodiment 6

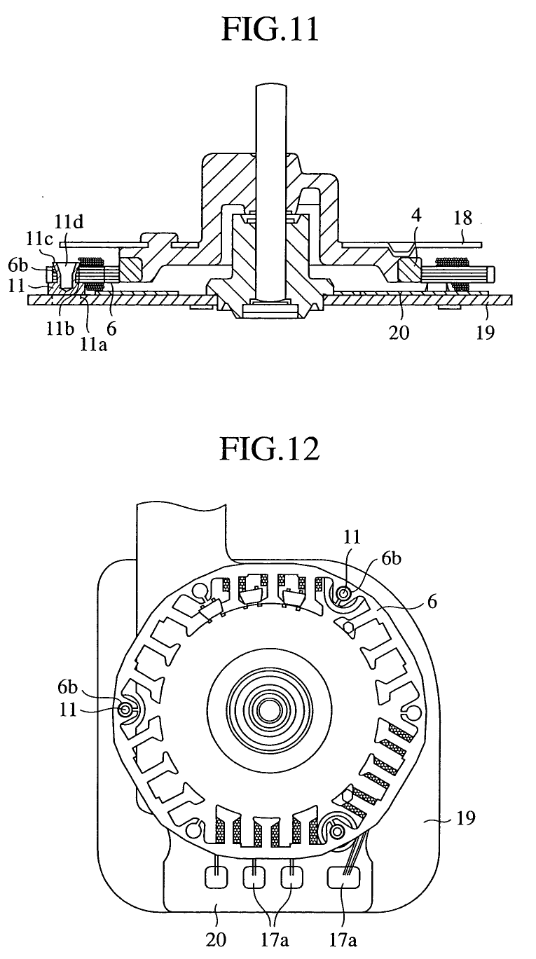

FIG. 11 is a transverse sectional view of a rotational driving device provided with a brushless motor in accordance with embodiment 6 of the present invention. FIG. 12 is a plan view of a main portion of the rotational driving device, in which the rotor part is removed in FIG. 11. At this point, the same parts as in FIG. 1 are denoted by the same reference symbols.

The inner-rotor-type brushless motors in the above described embodiments 1 to 5 have the same basic structure.

Another kind of inner-rotor-type brushless motor having a different structure from the above described brush less motors, is shown in FIGS. 11 and 12.

In a rotor part shown in FIG. 11, the ring magnet 4 and a dust preventing rotor plate 18 are made by insertion molding onto the rotor part. In a stator part, the fastening parts 11 are mounted on a motor base 19 and a flexible board 20 is put on the motor base 19 and then the iron core 6 is fastened and fixed to the motor base 19.

A method of fastening and fixing the iron core 6 by the fastening part 11 is the same as in FIG. 5.

As shown in FIG. 12, the iron core 6 is fastened and fixed to the motor base 19 by the fastening parts 11 at three through holes 6b, as is the case with FIG. 5.

As described above, according to this embodiment 6, the fastening parts 11 described in embodiment 1 are mounted to the motor base 19 of the inner-rotor-type brushless motor having a structure different from the structures in embodiments 1 to 5 and the iron core 6 is fastened and fixed to the motor base 19 with these fastening parts 11. With this structure, also in the inner-rotor-type brushless motor of a different kind, it is possible to produce the same effect as in embodiment 1, that is, an effect of providing a rotational driving device provided with a brushless motor which can prevent an increase in iron loss generated in the iron core 6 to prevent a decrease in motor efficiency and is resistant to vibrations and impact and hence can prevent the iron core 6 from being removed thereby to improve reliability.

1. A rotational driving device comprising:
a rotor part that has a rotary shaft and a ring magnet and rotates around the rotary shaft;
a stator part that has a plurality of teeth portions formed at nearly equal intervals on an inner peripheral edge of a ring-shaped iron core and magnetic field generating coils wound around the respective teeth portions and generates a magnetic field for rotating the rotor part; and
an electric circuit board on which an electric circuit for passing current through the magnetic field generating coils is formed and to which a bearing is fixedly mounted for supporting the rotary shaft, wherein
a plurality of through holes are made in a periphery of the iron core, and
a plurality of stepped fastening parts are provided on the electric circuit board each of which is fitted in each of the through holes and then is caulked to grip the iron core between its top and rest seat portion.

2. The rotational driving device as claimed in claim 1, wherein the fastening parts are integrally formed with the electric circuit board.

3. A rotational driving device comprising:
a rotor part that has a rotary shaft and a ring magnet and rotates around the rotary shaft;
a stator part that has a plurality of teeth portions formed at nearly equal intervals on an inner peripheral edge of a ring-shaped iron core and magnetic field generating coils wound around the respective teeth portions and generates a magnetic field for rotating the rotor part;
a base to which a bearing for supporting the rotary shaft is fixed; and
an electric circuit board on which an electric circuit for passing current through the magnetic field generating coils is formed, wherein
a plurality of through holes are made in a periphery of the iron core, and
a plurality of stepped fastening portions each of which is integrally formed with the base and is fitted in each of the through holes and then is caulked to grip the iron core between its top and rest seat portion.

4. The rotational driving device as claimed in claim 1, wherein a fitting portion of the stepped fastening part has a depression in its top and the depression is expanded outwardly.

5. The rotational driving device as claimed in claim 1, wherein a fitting portion of the stepped fastening part is formed in a shape of a column and its column-shaped top is swaged and expanded outwardly.

6. The rotational driving device as claimed in claim 3, wherein a plurality of fastening portions are integrally formed with the base so as to fasten the electric circuit board and fitting portions of the fastening portions are fitted in a plurality of fastening holes made in the electric circuit board and then top portions of the fitting portions are expanded and caulked to fasten and fix the electric circuit board to the base.

7. The rotational driving device as claimed in claim 1, wherein the rotor part includes a rotor housing having a plurality of cut and raised portions around the rotary shaft, a ring magnet mounted in the cut and raised portions, and a hole-sealing ring plate arranged between the rotor housing and the ring magnet so as to seal holes made by the cut and raised portions.
